(19) United States
(12) Patent Application Publication
(10) Pub. No.: US 2025/0169603 A1
(43) Pub. Date: May 29, 2025

(54) STORAGE RACK

(71) Applicant: Wei Wang, Huai'an City (CN)

(72) Inventor: Wei Wang, Huai'an City (CN)

(21) Appl. No.: 18/399,961

(22) Filed: Dec. 29, 2023

(30) Foreign Application Priority Data
Nov. 27, 2023 (CN) 202323199148.6

(51) Int. Cl. A47B 45/00; A47B 51/00

(52) U.S. Cl. CPC A47B 45/00; A47B 51/00; A47B 2051/005

(57) ABSTRACT

Provided is a storage rack, including connecting arms and a shelf, where the shelf includes first connectors; each first connector includes a first end, a second end, and a third end; the shelf further includes first transverse beams and first longitudinal beams; each first transverse beam is connected to the first end, each first longitudinal beam is connected to the second end, and each connecting arm is connected to the third end; and a specific angle is formed between every two of the connecting arm, the first transverse beam, and the first longitudinal beam.

### CROSS REFERENCE TO RELATED APPLICATION

This application claims priority benefit of Chinese design Application No. 202323199148.6, filed on Nov. 27, 2023, and the entire contents of which are incorporated herein by reference.

### TECHNICAL FIELD

This application relates to the field of storage equipment, and specifically relates to a storage rack.

### BACKGROUND

The storage rack is a living facility used to store items, often used in indoor environments such as homes, offices, basements, and garages, and usually mounted on a wall or ceiling. However, the storage rack in the prior art has a complex structure and high cost, and the complex structure easily leads to a higher risk of failure and a greater mounting error, such that the existing storage rack has low finished product quality and short service life.

### SUMMARY

Based on this, it is necessary to provide a storage rack, to solve at least one of the above problems.

The present application provides a storage rack, including connecting arms and a shelf, where the shelf includes first connectors; each of the first connectors includes a first end, a second end, and a third end; the shelf further includes first transverse beams and first longitudinal beams; each of the first transverse beams is connected to the first end, each of the first longitudinal beams is connected to the second end, and each of the connecting arms is connected to the third end; and a specific angle is formed between every two of the connecting arm, the first transverse beam, and the first longitudinal beam.

Further, the shelf further includes second connectors; each of the second connectors includes a fifth end, a sixth end, and a seventh end; there are a plurality of first connectors and a plurality of first longitudinal beams; the plurality of first connectors include the first connectors corresponding to the fifth ends and the first connectors corresponding to the sixth ends; the plurality of first longitudinal beams include the first longitudinal beams connected between the second ends and the fifth ends and the first longitudinal beams connected between the second ends and the sixth ends; the first longitudinal beams connected between the second ends and the fifth ends are separately connected to the first connectors corresponding to the fifth ends and the second connectors, and the first longitudinal beams connected between the second ends and the sixth ends are separately connected to the first connectors corresponding to the sixth ends and the second connectors; the shelf further includes the first transverse beams corresponding to the seventh ends; and the first transverse beams corresponding to the seventh ends are connected to the seventh ends.

Further, the shelf further includes third connectors; each of the third connectors includes an eighth end, a ninth end, a tenth end, and an eleventh end; the plurality of first connectors further include the first connectors corresponding to the eighth ends and the first connectors corresponding to the tenth ends; the plurality of first longitudinal beams include the first longitudinal beams connected between the second ends and the eighth ends and the first longitudinal beams connected between the second ends and the tenth ends; the first longitudinal beams connected between the second ends and the eighth ends are separately connected to the first connectors corresponding to the eighth ends and the third connectors, and the first longitudinal beams connected between the second ends and the tenth ends are separately connected to the first connectors corresponding to the tenth ends and the third connectors; the seventh ends of the second connectors are corresponding to the ninth ends of the third connectors; the first transverse beams corresponding to the seventh ends are connected between the seventh ends and the ninth ends; there are a plurality of connecting arms; the plurality of connecting arms include the connecting arms corresponding to the eleventh ends; and the connecting arms corresponding to the eleventh ends are connected to the eleventh ends.

Further, each of the first connectors further includes a fourth end; the fourth end is arranged opposite to the third end; a second insertion slot penetrating through the fourth end and the third end is provided between the fourth end and the third end; and each of the connecting arms penetrates through the third end and extends out of the fourth end.

Further, each of the third connectors further includes a twelfth end; the twelfth end is arranged opposite to the eleventh end; a fifth insertion slot penetrating through the twelfth end and the eleventh end is provided between the twelfth end and the eleventh end; and each of the connecting arms penetrates through the eleventh end and extends out of the twelfth end.

Further, the connections are detachable connections.

Further, each of the connecting arms includes a first plate, a first structural member, and a second structural member; the second structural member has one end detachably connected to the third end and the other end detachably connected to one end of the first structural member; and the other end of the first structural member is detachably connected to the first plate.

Further, the first plate is square; four corners of the first plate are provided with four first holes, respectively; and the first holes are configured to fix the first plate to a mounting surface.

Further, a first angle steel is arranged on one side, facing the first structural member, of the first plate; the first angle steel is provided with second holes; the first structural member includes a second angle steel and a plurality of fourth holes arranged in sequence along a length direction of the second angle steel, the first plate is detachably connected to the fourth holes of the first structural member through the second holes, and the first plate is connected to the fourth holes in different positions to adjust a height of the first plate relative to the first structural member; and/or, the second structural member includes a third angle steel and a plurality of sixth holes arranged in sequence along a length direction of the third angle steel, the second structural member is detachably connected to the sixth holes of the second structural member through the fourth holes, and the first structural member is connected to the sixth holes in different positions to adjust a height of the first structural member relative to the second structural member.

Further, the shelf further includes a plurality of first joints, a plurality of second joints, second transverse beams, and second longitudinal beams; the second transverse beams are fixedly connected to the first longitudinal beams through the first joints; the second longitudinal beams are fixedly connected to the first transverse beams through the first joints; the second transverse beams are fixedly connected to the second longitudinal beams through the second joints; and/or, the shelf further includes a cover plate; the cover plate includes a third flange, a longitudinal bracket, a transverse bracket, and a second plate; the third flange is arranged on a peripheral side of the second plate; at least part of the third flange is corresponding to the second transverse beams, at least part of the longitudinal bracket is corresponding to the second transverse beams, and at least part of the transverse bracket is corresponding to the second transverse beams; and the second plate is supported on the second transverse beams through the third flange, the longitudinal bracket, and the transverse bracket.

The storage rack is provided with the first connectors capable of simultaneously connecting the connecting arms, the first transverse beams, and the first longitudinal beams, such that the total number of the connectors can be effectively reduced, more stable and firmer mounting and storage are facilitated, the cost of the storage rack can be reduced, the risk of failure in the connectors can be lowered, and a mounting error caused by the connectors during connection is reduced, thereby improving the service life and quality of the storage rack.

### BRIEF DESCRIPTION OF THE DRAWINGS

The accompanying drawings are only for illustrative purposes and cannot be understood as a limitation on this patent; and the same reference signs are used for members with the same structure and function. In the drawings:

FIG. 1 is a schematic diagram of an overall structure of a storage rack according to one embodiment of the present application;

FIG. 2 is a schematic diagram of an overall structure of a storage rack according to another embodiment of the present application;

FIG. 3 is a schematic structural diagram of a shelf according to one embodiment of the present application;

FIG. 4 is a schematic structural diagram of a first plate according to one embodiment of the present application;

FIG. 5 is a schematic structural diagram of a first structural member according to one embodiment of the present application;

FIG. 6 is a schematic structural diagram of a second structural member according to one embodiment of the present application;

FIG. 7 is a schematic structural diagram of a first joint according to one embodiment of the present application;

FIG. 8 is a schematic structural diagram of a second joint according to one embodiment of the present application;

FIG. 9 is a schematic structural diagram of a first transverse beam according to one embodiment of the present application;

FIG. 10 is a schematic structural diagram of a first longitudinal beam according to one embodiment of the present application;

FIG. 11 is a schematic structural diagram of a second transverse beam according to one embodiment of the present application;

FIG. 12 is a schematic structural diagram of a second longitudinal beam according to one embodiment of the present application;

FIG. 13 is a schematic structural diagram of a cover plate according to one embodiment of the present application; and

FIG. 14 is a schematic diagram of an exploded structure of a third longitudinal beam, a second connector, a first transverse beam, and two first longitudinal beams according to one embodiment of the present application.

Description of reference signs: storage rack—1; connecting arm—10; first plate—101; first hole—1011; first angle steel—1012; second hole—1013; third hole—1014; first structural member—102; second angle steel—1021; fourth hole—1022; fifth hole—1023; second structural member—103; third angle steel—1031; sixth hole—1032; seventh hole—1033; shelf—20; first connector—201; first end—2011; second end—2012; third end—2013; fourth end—2014; first insertion slot—2015; second insertion slot—2016; first straight slot—2017; eighth hole—2018; ninth hole—2019; second connector—202; fifth end—2021; sixth end—2022; seventh end—2023; third insertion slot—2024; seventh hole—2025; second straight slot—2026; third connector—203; eighth end—2031; ninth end—2032; tenth end—2033; eleventh end—2034; twelfth end—2035; fourth insertion slot—2036; fifth insertion slot—2037; third straight slot—2038; eighth hole—2039; ninth hole—20310; first joint—204; first flange—2041; first slot—2042; first connecting part—2043; second joint—205; second flange—2051; second slot—2052; second connecting part—2053; first transverse beam—206; tenth hole—2061; sixth insertion slot—2062; first longitudinal beam—207; eleventh hole—2071; seventh insertion slot—2072; second transverse beam—208; second longitudinal beam—209; cover plate—210; third flange—2101; longitudinal bracket—2102; transverse bracket—2103; second plate—2104; and third longitudinal beam—211.

### DETAILED DESCRIPTION OF THE EMBODIMENTS

The technical solutions in the embodiments of the present application will be described below with reference to the accompanying drawings in the embodiments of the present application. In the description of the embodiments of the present application, unless otherwise specified, “/” means or, for example, A/B may mean A or B; and “and/or” herein is merely intended to describe an association relationship of associated objects, indicating that three relationships may exist, for example, A and/or B may mean that only A, both A and B, or only B exists. In addition, in the description of the embodiments of the present application, “a plurality of” refers to two or more.

Hereinafter, the terms “first” and “second” are only for descriptive purposes, and cannot be construed as indicating or implying relative importance or implying the number of technical features indicated. Thus, the features defined with “first” and “second” may explicitly or implicitly include one or more of the features.

The inventor of this application has found through research that shelves of an existing storage rack usually need to be connected by a plurality of beams and also need to be connected to a wall or ceiling by using different connectors, which leads to a great number of connectors, such that storage is not facilitated and the cost of the storage rack is increased; moreover, the greater the number of the connectors is, the higher the risk of failure in the connectors is, and the bigger the mounting error caused by the connectors during connection is, such that the risk of failure in the connectors of the storage rack and the overall mounting error of the storage rack are increased, thereby reducing the service life and quality of the storage rack.

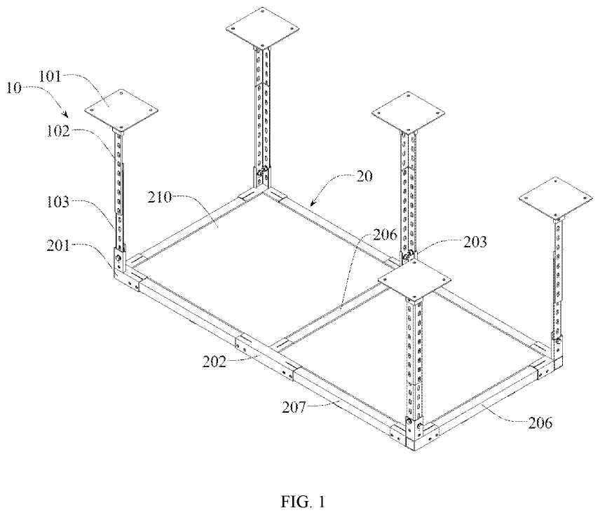

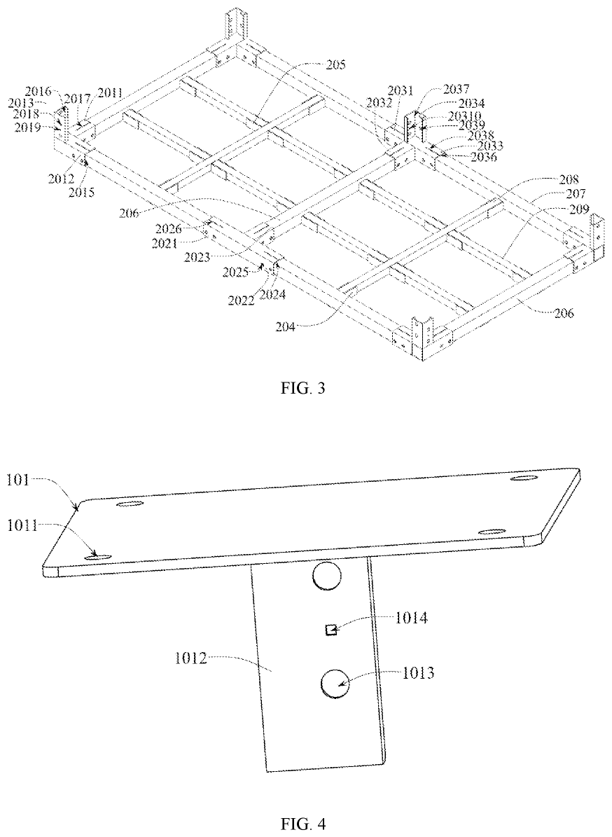

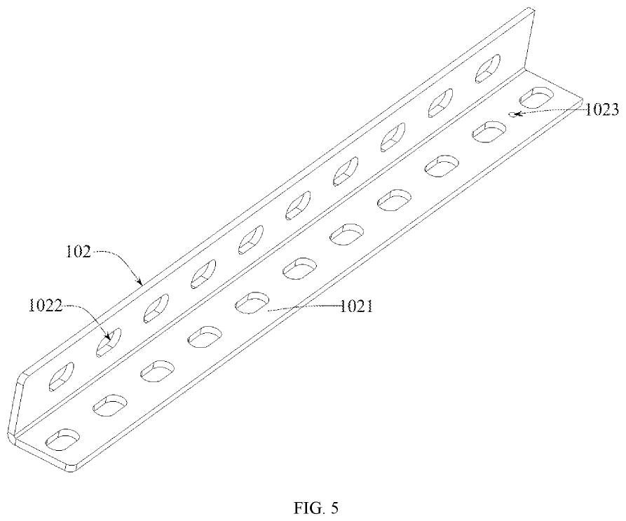

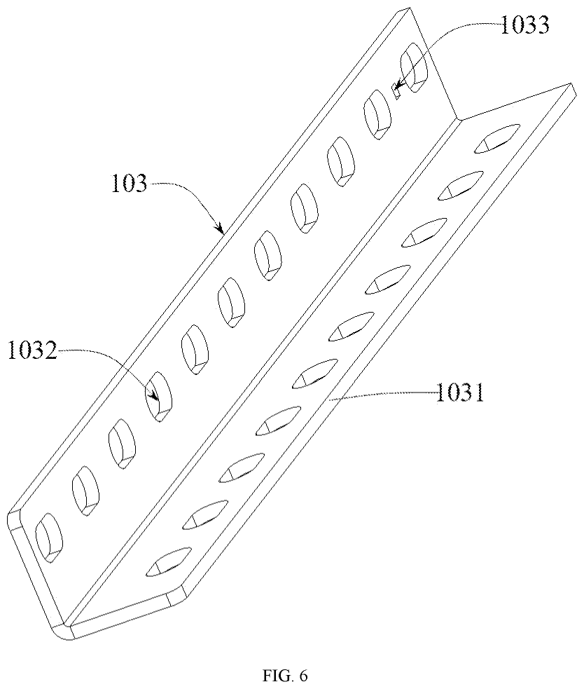

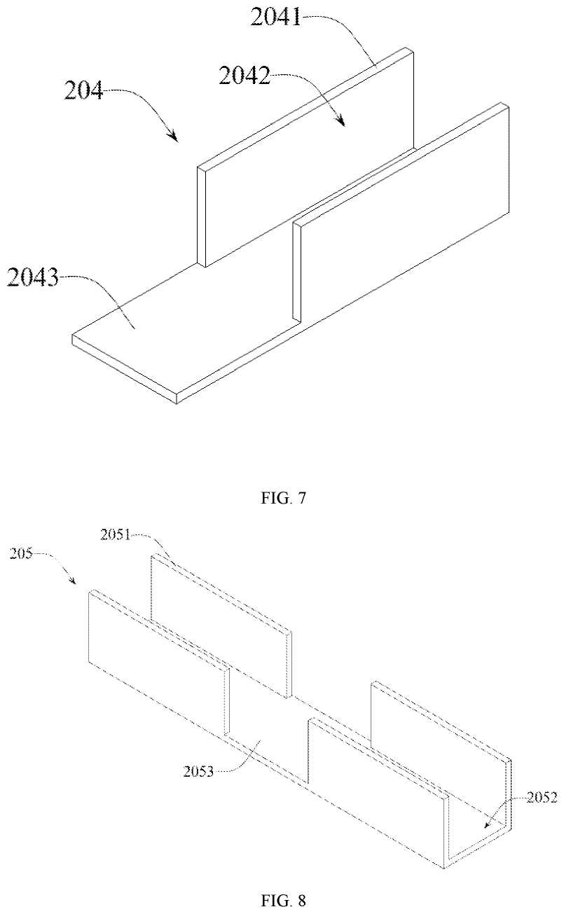

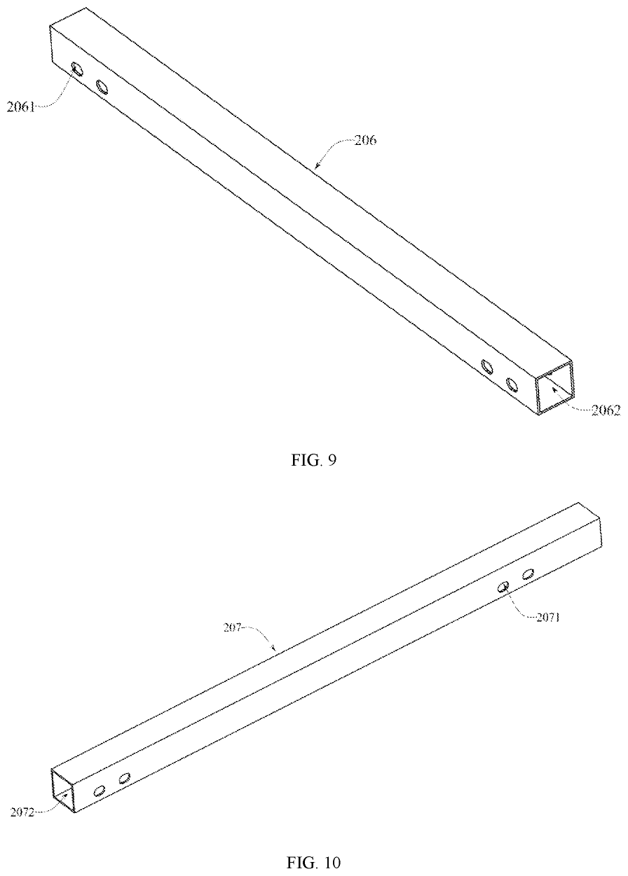

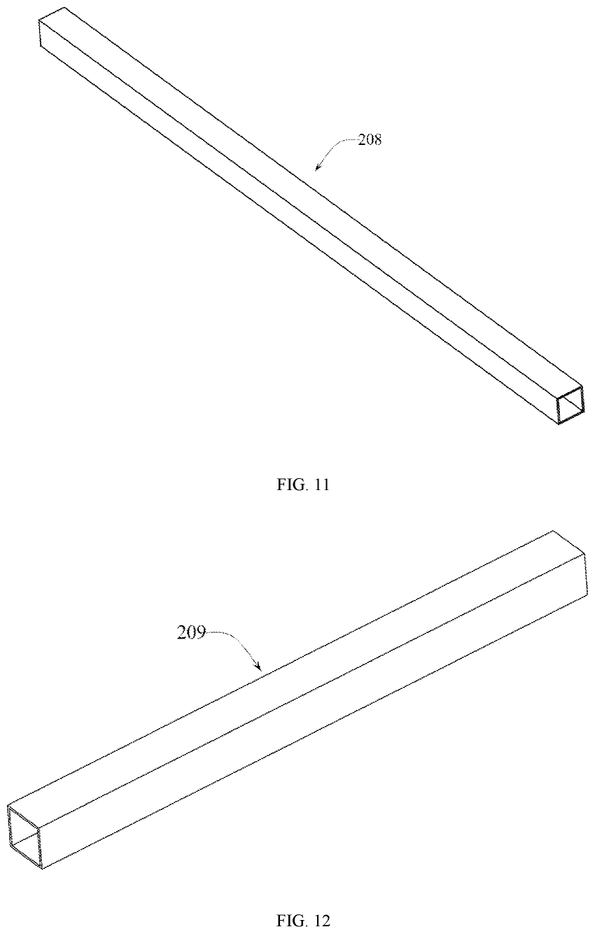

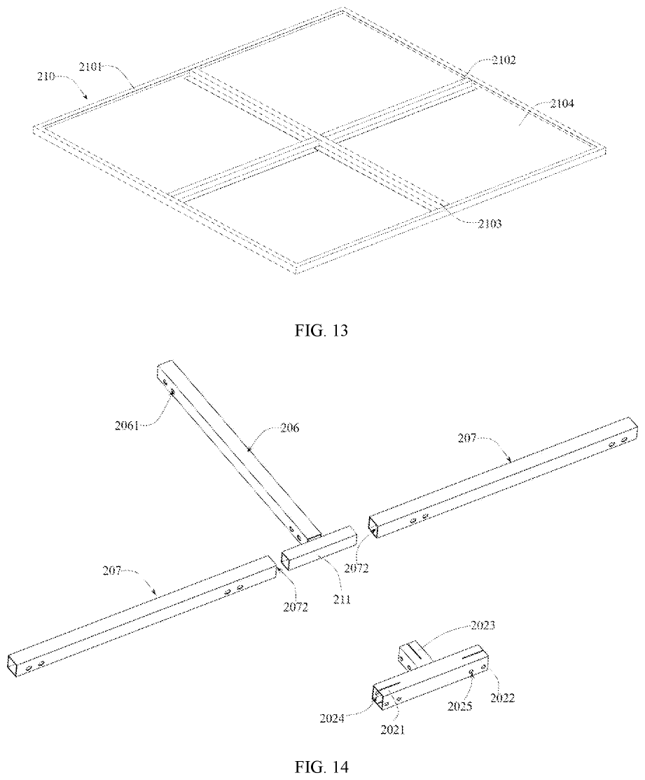

Referring to FIG. 1 to FIG. 14, this embodiment provides a storage rack 1, including connecting arms 10 and a shelf 20, where the shelf 20 includes first connectors 201; each of the first connectors 201 includes a first end 2011, a second end 2012, and a third end 2013; the shelf 20 further includes first transverse beams 206 and first longitudinal beams 207; each of the first transverse beams 206 is connected to the first end 2011, each of the first longitudinal beams 207 is connected to the second end 2012, and each of the connecting arms 10 is connected to the third end 2013; and a specific angle is formed between every two of the connecting arm 10, the first transverse beam 206, and the first longitudinal beam 207.

In this embodiment, each of the connecting arms 10 includes a first plate 101, a first structural member 102, and a second structural member 103; the second structural member 103 has one end detachably connected to the third end 2013 and the other end detachably connected to one end of the first structural member 102; and the other end of the first structural member 102 is detachably connected to the first plate 101. The detachable connection may be, for example, a bolted connection, a riveted connection, or the like, but is not limited to this.

In this embodiment, the number of connecting arms 10 is five. It can be understood that in some embodiments, the number of connecting arms 10 may also be one, two, three, or another.

In this embodiment, the first plate 101 is square; four corners of the first plate 101 are provided with four first holes 1011, respectively; and the first holes 1011 are configured to fix the first plate 101 to an indoor mounting surface. In this way, the storage rack 1 can be mounted on the indoor mounting surface through the square first plate 101 of the connecting arm 10 and is fixed at the four corners of the first plate 101, thus effectively improving the stability and firmness of mounting.

In this embodiment, a first angle steel 1012 is arranged on one side, facing the first structural member 102, of the first plate 101; the first angle steel 1012 is provided with a plurality of second holes 1013; the first structural member 102 includes a second angle steel 1021 and a plurality of fourth holes 1022 arranged in sequence along a length direction of the second angle steel 1021; the first plate 101 is detachably connected to the fourth holes 1022 of the first structural member 102 through the second holes 1013; and the first plate 101 is connected to the second holes 1013 in different positions or the fourth holes 1022 in different positions to adjust a height of the first plate 101 relative to the first structural member 102. The detachable connection may be, for example, a bolted connection, a riveted connection, or the like, but is not limited to this.

In this embodiment, the first angle steel 1012 further includes a third hole 1014, and the first structural member 102 further includes a fifth hole 1023. The third hole 1014 of the first angle steel 1012 is aligned with the fifth hole 1023 to implement alignment of the first plate 101 and the first structural member 102.

In this embodiment, the second structural member 103 includes a third angle steel 1031 and a plurality of sixth holes 1032 arranged in sequence along a length direction of the third angle steel 1031; the first structural member 102 is detachably connected to the sixth holes 1032 of the second structural member 103 through the fourth holes 1022; and the first structural member 102 is connected to the fourth holes 1022 in different positions or the sixth holes 1032 in different positions to adjust a height of the first structural member 102 relative to the second structural member 103.

Optionally, the number of second holes 1013 is two. It can be understood that in some embodiments, the number of second holes 1013 may also be one, three, or another, but is not limited to this.

Optionally, the number of fourth holes 1022 is ten. It can be understood that in some embodiments, the number of fourth holes 1022 may also be one, two, three, or another, but is not limited to this.

Optionally, the number of sixth holes 1032 is eleven. It can be understood that in some embodiments, the number of sixth holes 1032 may also be one, two, three, or another, but is not limited to this.

In this embodiment, each of the first connectors 201 includes a fourth angle steel; and the fourth angle steel includes a first end 2011, a second end 2012, and a third end 2013.

In this embodiment, each of the first end 2011 and the second end 2012 is provided with a first insertion slot 2015; both the first transverse beam 206 and the first longitudinal beam 207 are square tubes; the first transverse beam 206 is inserted into the first insertion slot 2015 in the first end 2011; and the first longitudinal beam 207 is inserted into the first insertion slot 2015 in the second end 2012.

In this embodiment, the third end 2013 is provided with a second insertion slot 2016; and the second structural member 103 is inserted into the second insertion slot 2016.

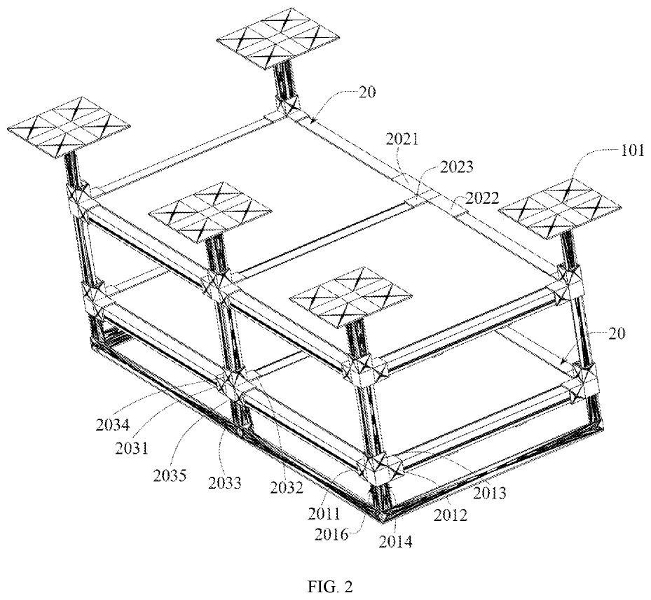

Referring to FIG. 2, optionally, the fourth angle steel further includes a fourth end 2014; the fourth end 2014 is arranged opposite to the third end 2013; a second insertion slot 2016 penetrating through the fourth end 2014 and the third end 2013 is provided between the fourth end 2014 and the third end 2013; and the second structural member 103 penetrates through the third end 2013 and extends out of the fourth end 2014. In this way, a height of the shelf 20 can be adjusted by adjusting a position, detachably connected to the first connector 201, of the second structural member 103.

In this embodiment, each of the first end 2011, the second end 2012, and the third end 2013 is provided with an eighth hole 2018; the first transverse beam 206 includes a tenth hole 2061 corresponding to the eighth hole 2018 in the first end 2011; the first transverse beam 206 is detachably connected to the eighth hole 2018 in the first end 2011 through the tenth hole 2061; the first longitudinal beam 207 includes an eleventh hole 2071 corresponding to the eighth hole 2018 in the second end 2012; the first longitudinal beam 207 is detachably connected to the eighth hole 2018 in the second end 2012 through the eleventh hole 2071; the second structural member 103 includes a sixth hole 1032 corresponding to the eighth hole 2018 in the third end 2013; and the second structural member 103 is detachably connected to the eighth hole 2018 in the third end 2013 through the sixth hole 1032. The detachable connection may be, for example, a bolted connection, a riveted connection, or the like, but is not limited to this.

In this embodiment, the third angle steel 1031 further includes a seventh hole 1033, and the fourth angle steel further includes a ninth hole 2019. The seventh hole 1033 of the third angle steel 1031 is aligned with the ninth hole 2019 to implement alignment of the second structural member 103 and the first connector 201.

In this embodiment, each of the first end 2011 and the second end 2012 is provided with a first straight slot 2017. In one of the functions of the first straight slot 2017, a bolt is clamped through slight deformation of the first straight slot 2017 in a tightening process when used to implement the detachable connection.

In this embodiment, the number of shelves 20 is one.

Referring to FIG. 2, optionally, the number of shelves 20 is two. It can be understood that in some embodiments, the number of shelves 20 may also be two, three, four, or another, but is not limited to this.

In this embodiment, the shelf further includes second connectors 202; each of the second connectors 202 includes a fifth end 2021, a sixth end 2022, and a seventh end 2023; there are a plurality of first connectors 201 and a plurality of first longitudinal beams 207; the plurality of first connectors 201 include the first connectors 201 corresponding to the fifth ends 2021 and the first connectors 201 corresponding to the sixth ends 2022; the plurality of first longitudinal beams 207 include the first longitudinal beams 207 connected between the second ends 2012 and the fifth ends 2021 and the first longitudinal beams 207 connected between the second ends 2012 and the sixth ends 2022; the first connectors 201 corresponding to the fifth ends 2021 are connected to the second connectors 202 through the first longitudinal beams 207 connected between the second ends 2012 and the fifth ends 2021; the first connectors 201 corresponding to the sixth ends 2022 are connected to the second connectors 202 through the first longitudinal beams 207 connected between the second ends 2012 and the sixth ends 2022; the shelf 20 further includes the first transverse beams 206 corresponding to the seventh ends 2023; and the first transverse beams 206 corresponding to the seventh ends 2023 are connected to the seventh ends 2023.

Optionally, the number of first connectors 201 is four. It can be understood that in some embodiments, the number of first connectors 201 may also be two, three, five, or another, but is not limited to this.

Optionally, the number of second connectors 202 is one. It can be understood that in some embodiments, the number of second connectors 202 may also be two, three, four, or another, but is not limited to this.

In this embodiment, each of the second connectors 202 includes a fifth angle steel; and the fifth angle steel includes a fifth end 2021, a sixth end 2022, and a seventh end 2023.

In this embodiment, each of the fifth end 2021, the sixth end 2022, and the seventh end 2023 is provided with a third insertion slot 2024; both the first transverse beam 206 and the first longitudinal beam 207 are square tubes; the first transverse beam 206 corresponding to the seventh end 2023 is inserted into the third insertion slot 2024 in the seventh end 2023; and the two first longitudinal beams 207 are inserted into the corresponding third insertion slots 2024 in the fifth end 2021 and the sixth end 2022, respectively.

In this embodiment, each of the fifth end 2021, the sixth end 2022, and the seventh end 2023 is provided with a seventh hole 2025; the first longitudinal beam 207 further includes an eleventh hole 2071 corresponding to the seventh hole 2025 in the fifth end 2021; the first longitudinal beam 207 connected between the second end 2012 and the fifth end 2021 is detachably connected to the seventh hole 2025 in the fifth end 2021 through the eleventh hole 2071; the first longitudinal beam 207 further includes an eleventh hole 2071 corresponding to the seventh hole 2025 in the sixth end 2022; the first longitudinal beam 207 connected between the second end 2012 and the sixth end 2022 is detachably connected to the seventh hole 2025 in the sixth end 2022 through the eleventh hole 2071; the first transverse beam 206 corresponding to the seventh end 2023 further includes a tenth hole 2061 corresponding to the seventh hole 2025 in the seventh end 2023; and the first transverse beam 206 corresponding to the seventh end 2023 is detachably connected to the seventh hole 2025 in the seventh end 2023 through the tenth hole 2061. The detachable connection may be, for example, a bolted connection, a riveted connection, or the like, but is not limited to this.

In this embodiment, each of the fifth end 2021, the sixth end 2022, and the seventh end 2023 is provided with a second straight slot 2026. In one of the functions of the second straight slot 2026, a bolt is clamped through slight deformation of the second straight slot 2026 in a tightening process when used to implement the detachable connection.

In this embodiment, the shelf 20 further includes a third longitudinal beam 211; the first longitudinal beam 207 further includes a seventh insertion slot 2072; a third insertion slot 2024 penetrating through the fifth end 2021 and the sixth end 2022 is provided between the fifth end 2021 and the sixth end 2022; the third longitudinal beam 211 is arranged in the third insertion slot 2024 penetrating through the fifth end 2021 and the sixth end 2022; and one end of the third longitudinal beam 211 is at least partially arranged in the seventh insertion slot 2072 of the first longitudinal beam 207 connected between the second end 2012 and the fifth end 2021, and the other end of the third longitudinal beam 211 is at least partially arranged in the seventh insertion slot 2072 of the first longitudinal beam 207 connected between the second end 2012 and the sixth end 2022. In this way, due to the arrangement of the third longitudinal beam 211, the second connector 202, the first longitudinal beam 207 connected between the second end 2012 and the fifth end 2021, and the first longitudinal beam 207 connected between the second end 2012 and the sixth end 2022 can be strengthened, thereby making the shelf 20 more stable and firmer in structure.

In this embodiment, the shelf 20 further includes third connectors 203; each of the third connectors 203 includes an eighth end 2031, a ninth end 2032, a tenth end 2033, and an eleventh end 2034; the plurality of first connectors 201 further include the first connectors 201 corresponding to the eighth ends 2031 and the first connectors 201 corresponding to the tenth ends 2033; the plurality of first longitudinal beams 207 further include the first longitudinal beams 207 connected between the second ends 2012 and the eighth ends 2031 and the first longitudinal beams 207 connected between the second ends 2012 and the tenth ends 2033; the first connectors 201 corresponding to the eighth ends 2031 are connected to the third connectors 203 through the first longitudinal beams 207 connected between the second ends 2012 and the eighth ends 2031; the first connectors 201 corresponding to the tenth ends 2033 are connected to the third connectors 203 through the first longitudinal beams 207 connected between the second ends 2012 and the tenth ends 2033; the seventh ends 2023 of the second connectors 202 are corresponding to the ninth ends 2032 of the third connectors 203; the first transverse beams 206 corresponding to the seventh ends 2023 are connected between the seventh ends 2023 and the ninth ends 2032; there are a plurality of connecting arms 10; the plurality of connecting arms 10 include the connecting arms 10 corresponding to the eleventh ends 2034; and the connecting arms 10 corresponding to the eleventh ends 2034 are connected to the eleventh ends 2034. It can be understood that in some embodiments, the third connector may also include only the eighth end 2031, the tenth end 2033, and the eleventh end 2034 without the ninth end 2032.

Optionally, the number of third connectors 203 is one. It can be understood that in some embodiments, the number of third connectors 203 may also be two, three, four, or another, but is not limited to this.

In this embodiment, each of the third connectors 203 includes a sixth angle steel; and the sixth angle steel includes an eighth end 2031, a ninth end 2032, a tenth end 2033, and an eleventh end 2034.

In this embodiment, each of the eighth end 2031, the ninth end 2032, and the tenth end 2033 is provided with a fourth insertion slot 2036; both the first transverse beam 206 and the first longitudinal beam 207 are square tubes; the first transverse beam 206 connected between the seventh end 2023 and the ninth end 2032 is inserted into the fourth insertion slot 2036 in the ninth end 2032; the first longitudinal beam 207 connected between the second end 2012 and the eighth end 2031 is inserted into the fourth insertion slot 2036 in the eighth end 2031; and the first longitudinal beam 207 connected between the second end 2012 and the tenth end 2033 is inserted into the fourth insertion slot 2036 in the tenth end 2033.

In this embodiment, the eleventh end 2034 is provided with a fifth insertion slot 2037; and the second structural member 103 corresponding to the eleventh end 2034 is inserted into the fifth insertion slot 2037.

Referring to FIG. 2, optionally, each of the third connectors 203 further includes a twelfth end 2035; the twelfth end 2035 is arranged opposite to the eleventh end 2034; a fifth insertion slot 2037 penetrating through the twelfth end 2035 and the eleventh end 2034 is provided between the twelfth end 2035 and the eleventh end 2034; and the second structural member 103 penetrates through the eleventh end 2034 and extends out of the twelfth end 2035. In this way, a height of the shelf 20 can be adjusted by adjusting a position, detachably connected to the third connector 203, of the second structural member 103.

In this embodiment, each of the eighth end 2031, the ninth end 2032, the tenth end 2033, and the eleventh end 2034 is provided with an eighth hole 2039; the first transverse beam 206 connected between the seventh end 2023 and the ninth end 2032 further includes a tenth hole 2061 corresponding to the eighth hole 2039 in the ninth end 2032; the first transverse beam 206 connected between the seventh end 2023 and the ninth end 2032 is detachably connected to the eighth hole 2039 in the ninth end 2032 through the tenth hole 2061; the first longitudinal beam 207 connected between the second end 2012 and the eighth end 2031 further includes an eleventh hole 2071 corresponding to the eighth hole 2039 in the eighth end 2031; the first longitudinal beam 207 connected between the second end 2012 and the eighth end 2031 is detachably connected to the eighth hole 2039 in the eighth end 2031 through the eleventh hole 2071; the first longitudinal beam 207 connected between the second end 2012 and the tenth end 2033 further includes an eleventh hole 2071 corresponding to the eighth hole 2039 in the tenth end 2033; the first longitudinal beam 207 connected between the second end 2012 and the tenth end 2033 is detachably connected to the eighth hole 2039 in the tenth end 2033 through the eleventh hole 2071; the second structural member 103 corresponding to the eleventh end 2034 further includes a sixth hole 1032 corresponding to the eighth hole 2039 in the eleventh end 2034; and the second structural member 103 corresponding to the eleventh end 2034 is detachably connected to the eighth hole 2039 in the eleventh end 2034 through the sixth hole 1032. The detachable connection may be, for example, a bolted connection, a riveted connection, or the like, but is not limited to this.

In this embodiment, each of the eighth end 2031, the ninth end 2032, and the tenth end 2033 is provided with a third straight slot 2038. In one of the functions of the third straight slot 2038, a bolt is clamped through slight deformation of the third straight slot 2038 in a tightening process when used to implement the detachable connection.

Optionally, the number of first transverse beams 206 is three. It can be understood that in some embodiments, the number of first transverse beams 206 may also be one, two, three, or another, but is not limited to this.

Optionally, the number of first longitudinal beams 207 is four. It can be understood that in some embodiments, the number of first longitudinal beams 207 may also be one, two, three, or another, but is not limited to this.

In this embodiment, the shelf further includes a plurality of first joints, a plurality of second joints, second transverse beams, and second longitudinal beams; the second transverse beams are fixedly connected to the first longitudinal beams through the first joints; the second longitudinal beams are fixedly connected to the first transverse beams through the first joints; and the second transverse beams are fixedly connected to the second longitudinal beams through the second joints. The fixed connection may be, for example, a welded connection, a riveted connection, a bonded connection, or the like, but is not limited to this.

Optionally, the number of second transverse beams 208 is two. It can be understood that in some embodiments, the number of second transverse beams 208 may also be one, three, four, or another, but is not limited to this.

Optionally, the number of second longitudinal beams 209 is eight. It can be understood that in some embodiments, the number of second longitudinal beams 209 may also be one, two, three, four, or another, but is not limited to this.

In this embodiment, each of the first joints 204 includes a first channel steel; two first flanges 2041 arranged oppositely are provided on two sides of the first channel steel; a first slot 2042 is formed between the two first flanges 2041; the first channel steel further includes a first connecting part 2043 located outside the first slot 2042; one of the functions of the first slot 2042 is to limit a position of the second transverse beam 208 or the second longitudinal beam 209 while accommodating the second transverse beam 208 or the second longitudinal beam 209; and one of the functions of the first connecting part 2043 is to ensure that the first joint 204 is lapped on the first transverse beam 206 or the first longitudinal beam 207 and is fixedly connected to the first transverse beam 206 or the first longitudinal beam 207 at the first connecting part 2043. The fixed connection may be, for example, a welded connection, a riveted connection, a bonded connection, or the like, but is not limited to this.

Optionally, the number of first joints 204 is eight. It can be understood that in some embodiments, the number of first joints 204 may also be one, two, three, four, or another, but is not limited to this.

In this embodiment, each of the second joints 205 includes a second channel steel; a pair of second flanges 2051 arranged oppositely are provided at each of two ends of the second channel steel; the two second flanges 2051 in each pair of second flanges 2051 are arranged on two sides of the second channel steel, respectively; the two pairs of second flanges 2051 form two second slots 2052 located in two ends of the second channel steel, respectively; the second channel steel further includes a second connecting part 2053 located between the two second slots 2052; one of the functions of the second slots 2052 is to accommodate the second longitudinal beam 209; and one of the functions of the second connecting part 2053 is to ensure that the second joint 205 is lapped on the second transverse beam 208 and is fixedly connected to the second transverse beam 208 at the second connecting part 2053. The fixed connection may be, for example, a welded connection, a riveted connection, a bonded connection, or the like, but is not limited to this.

Optionally, the number of second joints 205 is six. It can be understood that in some embodiments, the number of second joints 205 may also be one, two, three, four, five, or another, but is not limited to this.

The shelf 20 further includes a cover plate 210; the cover plate 210 includes a third flange 2101, a longitudinal bracket 2102, a transverse bracket 2103, and a second plate 2104; the third flange 2101 is arranged on a peripheral side of the second plate 2104; at least part of the third flange 2101 is corresponding to the second transverse beams 208, at least part of the longitudinal bracket 2102 is corresponding to the second transverse beams 208, and at least part of the transverse bracket 2103 is corresponding to the second transverse beams 208; and the second plate is supported on the second transverse beams through the third flange 2101, the longitudinal bracket 2102, and the transverse bracket. In this way, the second plate may be supported more stably by the third flange 2101, the longitudinal bracket 2102, and the transverse bracket 2103, thereby placing items more stably. Optionally, the second plate 2104 is a solid plate. The solid second plate 2104 can be suitable to place items of different types and sizes without causing the placed items to leak out of the shelf 20 through a gap of a frame formed by lapping the first transverse beams 206, the second transverse beams 208, the first longitudinal beams 207, and the second longitudinal beams 209.

The storage rack 1 is provided with the first connectors 201, the second connectors 202, and the third connectors 203 capable of simultaneously connecting a plurality of structures, such that the total number of the connectors can be effectively reduced, more stable and firmer mounting and storage are facilitated, the cost of the storage rack 1 can be reduced, the risk of failure in the connectors can be lowered, and a mounting error caused by the connectors during connection is reduced, thereby improving the service life and quality of the storage rack 1.

In the description of this embodiment, “a plurality of” means two or more, unless otherwise stated. The above contents are only specific embodiments of the present application, but the scope of protection of the present application is not limited thereto. Any changes or substitutions within the technical scope of the present application should all be included within the scope of protection of the present application. Therefore, the scope of protection of the present application should be subject to the scope of protection of the claims.

What is claimed is:

1. A storage rack, comprising connecting arms and a shelf, wherein the shelf comprises first connectors; each of the first connectors includes a first end, a second end, and a third end; the shelf further comprises first transverse beams and first longitudinal beams; each of the first transverse beams is connected to the first end, each of the first longitudinal beams is connected to the second end, and each of the connecting arms is connected to the third end; and a specific angle is formed between every two of the connecting arm, the first transverse beam, and the first longitudinal beam.

2. The storage rack according to claim 1, wherein the shelf further comprises second connectors; each of the second connectors comprises a fifth end, a sixth end, and a seventh end; there are a plurality of first connectors and a plurality of first longitudinal beams; the plurality of first connectors comprise the first connectors corresponding to the fifth ends and the first connectors corresponding to the sixth ends; the plurality of first longitudinal beams comprise the first longitudinal beams connected between the second ends and the fifth ends and the first longitudinal beams connected between the second ends and the sixth ends; the first longitudinal beams connected between the second ends and the fifth ends are separately connected to the first connectors corresponding to the fifth ends and the second connectors, and the first longitudinal beams connected between the second ends and the sixth ends are separately connected to the first connectors corresponding to the sixth ends and the second connectors; the shelf further comprises the first transverse beams corresponding to the seventh ends; and the first transverse beams corresponding to the seventh ends are connected to the seventh ends.

3. The storage rack according to claim 2, wherein the shelf further comprises third connectors; each of the third connectors comprises an eighth end, a ninth end, a tenth end, and an eleventh end; the plurality of first connectors further comprise the first connectors corresponding to the eighth ends and the first connectors corresponding to the tenth ends; the plurality of first longitudinal beams further comprise the first longitudinal beams connected between the second ends and the eighth ends and the first longitudinal beams connected between the second ends and the tenth ends; the first longitudinal beams connected between the second ends and the eighth ends are separately connected to the first connectors corresponding to the eighth ends and the third connectors, and the first longitudinal beams connected between the second ends and the tenth ends are separately connected to the first connectors corresponding to the tenth ends and the third connectors; the seventh ends of the second connectors are corresponding to the ninth ends of the third connectors; the first transverse beams corresponding to the seventh ends are connected between the seventh ends and the ninth ends; there are a plurality of connecting arms; the plurality of connecting arms comprise the connecting arms corresponding to the eleventh ends; and the connecting arms corresponding to the eleventh ends are connected to the eleventh ends.

4. The storage rack according to claim 1, wherein each of the first connectors further comprises a fourth end; the fourth end is arranged opposite to the third end; a second insertion slot penetrating through the fourth end and the third end is provided between the fourth end and the third end; and each of the connecting arms penetrates through the third end and extends out of the fourth end.

5. The storage rack according to claim 3, wherein each of the third connectors further comprises a twelfth end; the twelfth end is arranged opposite to the eleventh end; a fifth insertion slot penetrating through the twelfth end and the eleventh end is provided between the twelfth end and the eleventh end; and each of the connecting arms penetrates through the eleventh end and extends out of the twelfth end.

6. The storage rack according to claim 1, wherein the connections are detachable connections.

7. The storage rack according to claim 1, wherein each of the connecting arms comprises a first plate, a first structural member, and a second structural member; the second structural member has one end detachably connected to the third end and the other end detachably connected to one end of the first structural member; and the other end of the first structural member is detachably connected to the first plate.

8. The storage rack according to claim 7, wherein the first plate is square; four corners of the first plate are provided with four first holes, respectively; and the first holes are configured to fix the first plate to a mounting surface.

9. The storage rack according to claim 7, wherein a first angle steel is arranged on one side, facing the first structural member, of the first plate; the first angle steel is provided with second holes; the first structural member comprises a second angle steel and a plurality of fourth holes arranged in sequence along a length direction of the second angle steel, the first plate is detachably connected to the fourth holes of the first structural member through the second holes, and the first plate is connected to the fourth holes in different positions to adjust a height of the first plate relative to the first structural member; and/or, the second structural member comprises a third angle steel and a plurality of sixth holes arranged in sequence along a length direction of the third angle steel, the second structural member is detachably connected to the sixth holes of the second structural member through the fourth holes, and the first structural member is connected to the sixth holes in different positions to adjust a height of the first structural member relative to the second structural member.

10. The storage rack according to claim 1, wherein the shelf further comprises a plurality of first joints, a plurality of second joints, second transverse beams, and second longitudinal beams; the second transverse beams are fixedly connected to the first longitudinal beams through the first joints; the second longitudinal beams are fixedly connected to the first transverse beams through the first joints; the second transverse beams are fixedly connected to the second longitudinal beams through the second joints; and/or, the shelf further comprises a cover plate; the cover plate comprises a third flange, a longitudinal bracket, a transverse bracket, and a second plate; the third flange is arranged on a peripheral side of the second plate; at least part of the third flange is corresponding to the second transverse beams, at least part of the longitudinal bracket is corresponding to the second transverse beams, and at least part of the transverse bracket is corresponding to the second transverse beams; and the second plate is supported on the second transverse beams through the third flange, the longitudinal bracket, and the transverse bracket.
